(19) United States
(12) Patent Application Publication
(10) Pub. No.: US 2017/0011548 A1
(43) Pub. Date: Jan. 12, 2017

(54) SYSTEM AND METHOD FOR 3-D MASSING OF A BUILDING ENVELOPE

(71) Applicant: SHoP Architects PC, New York, NY (US)

(72) Inventors: Todd Michael Sigaty, New York, NY (US); Eugene Jerome Pasquarelli, New York, NY (US); Gregg Andrew Pasquarelli, New York, NY (US); Timothy Michael Martone, New York, NY (US); Sarah Elizabeth Williams, Brooklyn, NY (US)

(73) Assignee: SHoP Architects PC, New York, NY (US)

(21) Appl. No.: 15/270,850

(22) Filed: Sep. 20, 2016

Related U.S. Application Data
(63) Continuation of application No. 13/473,137, filed on May 16, 2012.
(60) Provisional application No. 61/487,062, filed on May 17, 2011.

(51) Int. Cl. G06T 17/05; G06T 15/00; G06Q 50/16

(52) U.S. Cl. CPC G06T 17/05; G06Q 50/165; G06T 15/005; G06T 2200/24; G06T 2210/04

(57) ABSTRACT

A system and method processes data and implements geographic based queries to allow users to visualize 3-D representations or massings of a building considering various zoning parameters for a real estate parcel. The user can choose to output the resulting information in digital and/or print format and perform 3-D massing for any lot or combination of lots on a city block. Using stored and/or input data, the system calculates the viability of the property as a real estate development investment by calculating a discounted cash flow (DCF) and/or an internal rate of return (IRR) and/or other investment metric values.

### CROSS REFERENCE TO RELATED APPLICATIONS DATA

This application is a continuation of U.S. patent application Ser. No. 13/473,137 filed on May 16, 2012 which claims the benefit of U.S. Provisional Patent Application Ser. No. 61/487,062, filed on May 17, 2011, the contents of which are incorporated herein by reference their entirety.

### FIELD

The present disclosure relates to real estate development and more particularly to computer-based systems and methods for 3-D massing of a building envelope.

### BACKGROUND

Typically, the design and massings of a building are dependent upon multiple variables related to the lot dimensions, zoning constraints, design parameters, finances, and other variables. A massing envelope of a building, whether during due diligence for a potential development, or as an initial step in concept design, typically requires input from, among others, a real estate agent, a zoning attorney, an architect, and/or a financial advisor. The time and cost for such services can be substantial, and even an impediment to being able to make an informed decision about a specific building site.

### SUMMARY

In an illustrative embodiment, the systems and methods disclosed herein combine public Geographic Information Systems (GIS) data files, local real estate (e.g. PLUTO) data, zoning data, and financial data on selected parcels or combinations of parcels. Further, using stored or input data identifying development costs including acquisition, site preparation, and construction costs, and stored or input data identifying property sales and lease rates, the system calculates the viability of the property as a real estate investment by calculating an Internal Rate of Return (IRR) and other financial analytical results. The results of the geographic queries allow users to visualize 3-D representations/massings of the various zoning parameters within seconds. The user can then choose to output the resulting information in digital and/or print format.

In an illustrative embodiment, a computer-based system for 3-D massing of a building envelope is disclosed. Illustratively, the computer-based system includes a graphical user interface, a database in communication with the graphical user interface, and a processor in communication with the database and the graphical user interface. The processor is configured to receive a property address, obtain data from the database based on the address, convert the address to a parcel identifier identifying a parcel, display a land area diagram including the parcel, determine a floor area allowance value for the parcel, calculate a lot coverage amount for the parcel, calculate a rear yard requirement amount for the parcel, determine a priority between the lot coverage amount and the rear yard requirement, calculate a rear yard line based on the priority, calculate a building envelope for the parcel, calculate a floor area ratio for the parcel, and calculate an investment viability value for the parcel.

### BRIEF DESCRIPTION OF THE DRAWINGS

The systems and methods disclosed herein are illustrated in the figures of the accompanying drawings which are meant to be exemplary and not limiting, in which like references are intended to refer to like or corresponding parts, and in which:

FIG. 1 illustrates and embodiment of a flow diagram of an overview of information sources and outputs in a system and method according to the invention;

FIG. 2 illustrates an embodiment of a flow diagram for creating a spatial database;

FIG. 3 illustrates an overlay of specific data elements that can be included or overlaid onto GIS points;

FIG. 4A illustrates an example of zoning parameter data;

FIG. 4B illustrates an example of information in a spatial database;

FIG. 5 illustrates a flow diagram for creating a zone database;

FIG. 6 illustrates a flow diagram for creating an address lookup database;

FIG. 7 illustrates a flow diagram for generating a massing model;

FIG. 8 illustrates lot coverage and rear yard requirement;

FIG. 9 illustrates a rear yard line for an interior lot;

FIG. 10 illustrates street footage for a corner lot;

FIG. 11 illustrates a massing for interior through-lots;

FIG. 12 illustrates a flow diagram of the steps of a method for 3-D massing of a building envelope;

FIG. 13 illustrates a screen shot of an address entry screen;

FIG. 14 illustrates a screen shot of a lot selection screen;

FIG. 15 illustrates a screen shot of a use option selection screen;

FIG. 16 illustrates a screen shot of a zoning options selection screen;

FIG. 17 illustrates a diagram of a 3-D massing screen;

FIG. 18 illustrates a screen shot of a massing parameter selection screen;

FIG. 19A illustrates a screen shot of a 3-D massing output for a proposed building;

FIG. 19B illustrates a screen shot of a floorplate breakdown chart for the proposed building; and

FIG. 20 illustrates a flow diagram of calculating an internal rate of return value.

### DETAILED DESCRIPTION

Detailed embodiments of systems and methods for 3-D massing of a building envelope are disclosed herein, however, it is to be understood that the disclosed embodiments are merely exemplary, and the systems and methods may be embodied in various forms. Therefore, specific functional details disclosed herein are not to be interpreted as limiting, but merely as a basis for the claims and as a representative basis for teaching one skilled in the art to variously employ the systems and methods disclosed herein.

Generally, the systems and methods disclosed herein include and may be implemented within a computer system or network of computer systems having one or more databases and other storage apparatuses, servers, and additional components, such as processors, modems, terminals and displays, computer-readable media, algorithms, modules, and other computer-related components. The computer systems are especially configured and adapted to perform the functions and processes of the systems and methods as disclosed herein.

Communications between components in the systems and methods disclosed herein may be bidirectional electronic communication through a wired or wireless network. For example, one component may be networked directly, indirectly, through a third party intermediary, wirelessly, over the Internet, or otherwise with another component to enable communication between the components.

In an illustrative embodiment, the system for 3-D massing of a building envelope is a computer-based system including a graphical user interface, a processor, and one or more databases. Illustratively, the graphical user interface, processor and one or more databases are in bidirectional electronic communication through a wired or wireless network.

In an illustrative embodiment, the system combines data associated with property, land use, and zoning from numerous sources, such as database information that is publically available and/or available under a license agreement through city agencies and/or other database managers, and creates one or more specialized databases for use within or by the system and a method for 3-D massing of a building envelope.

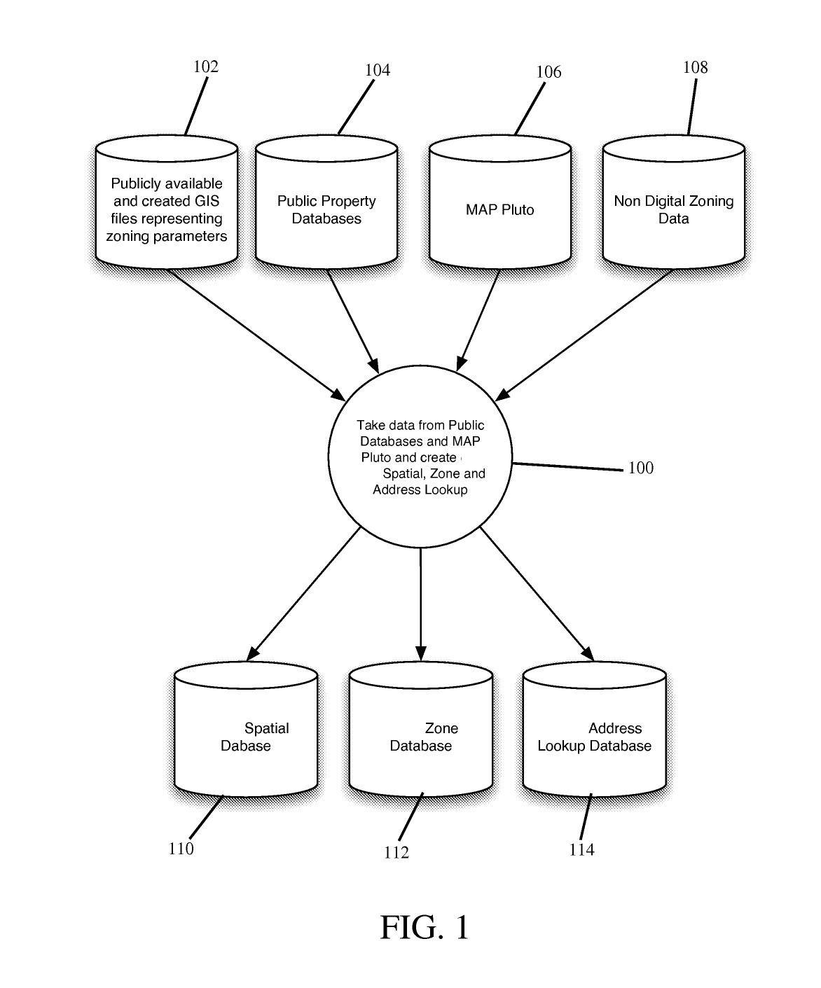

A flow diagram of an overview of information sources and outputs according to and illustrative embodiment is described with reference to FIG. 1. As illustrated in FIG. 1, the system 100 obtains and/or receives input data from one or more of a public Geographic Information Systems (GIS) data files 102, public property databases 104, MapPLUTO™ data files 106, and non-digital zoning data 108. Additionally, the system 100 may obtain and/or receive financial data related to parcels and combinations of parcels.

The public Geographic Information Systems (GIS) data files 102 may include any public GIS that captures, stores, analyzes, manages and presents data with reference to geographic location data, such as through state and city agencies and other GIS database managers. The public property databases 104 may include property databases managed by state and city agencies, or other property database managers. For example, a state or city planning department typically maintains property databases and information about each site in the city or state.

The MapPLUTO™ data files 106 are generally obtained from PLUTO which is a universal database that includes every city in the United States. PLUTO is a publicly accessible database which most cities typically use and can license out or make available for free. MapPLUTO™ merges PLUTO tax lot data with tax lot features from, for example, the New York City Department of Finance's Digital Tax Map (DTM), clipped to the shoreline. MapPLUTO™ contains extensive land use and geographic data at the tax lot level in Environmental Systems Research Institute (ESRI) ArcGIS shape format and database table format. An ESRI shapefile or shapefile is a geospatial vector data format for GIS software. The shapefile typically stores geometric location and associated attribute information, and generally includes one or more of the following file types: .shp, .shx, .dbf, .prj, .sbn, .sbx, .fbn, .fbx, .ain, .aih, .ixs, .mxs, .atx, .shp.xml, and .cpg.

Further, other city and state open source ESRI shapefiles can be used to further define zoning geography, corner lots, and park locations. In an illustrative embodiment, the system 100 may be permitted, for example through a license agreement, to use other software, data, and geographic base map files for a specific city or state. For example, the system 100 may be permitted, through a license agreement, to use BYTES of the BIG APPLE, which is a family of software, data, and geographic base map files for the City of New York.

The non-digital zoning data 108 may include the actual textual pages of a zoning code for a state and/or municipality, for example the text of the Zoning Resolution of the City of New York (1961) with amendments. Generally, the zoning data 108 is not in digital format, but rather is a text document that can be converted for digital processing as disclosed herein.

The system 100 processes the input data from the various sources (i.e. the public GIS data files 102, the public property databases 104, the MapPLUTO™ data files 106, and the non-digital zoning data 108) and creates one or more specialized databases from the input data. As illustrated in FIG. 1, a spatial database 110, a zone database 112, and an address lookup database 114 are created. The spatial database 110 may be created by the system 100 by re-drawing the GIS codes or mapping codes. In an illustrative embodiment, the GIS mapping codes may be mapped, and coordinates may be filled in and recoded. For example, every lot in the entire city of New York can be mapped, re-numbered and re-coordinated to produce the spatial database 110 which may include GIS data having not just a public code for every lot but also a special spatial database code.

The zone database 112 is generally created by the system 100 by digitizing and translating the key parameters of the non-digital zoning data 108, such as height, setback, number of variables, etc, that are important for massing a site. The non-digital zoning data 108 can be taken out of the text tool format and re-coded into numbers based on the types of zones for specific properties. This allows the system 100 to create computer code for all the different possibilities of parameters for each of the key parameters. Thus, the system 100 is able to mass any building in the address lookup database 114 or show the type of building that can be legally built on a particular property or parcel according to the elected parameters.

The address lookup database 114 is illustratively a database that allows a user to access the specialized property databases just by knowing a block and lot number or by knowing the physical address of a parcel. Further, the lookup database 114 may include code that recognizes a block and lot number or address the user enters and displays to the user a variety of information (such as ownership) about that lot just by knowing the address. More generally, the system 100 adds code to the public information so that if the user does not have a complete address or enters in an abbreviation for an address the system can still find the proper address or give a list of choices to present back to the user. More particularly, the system 100 parses the public address and zoning databases to remove extraneous data. The system 100 then adds an abbreviation table to the address lookup database 114 that allows for address and BBL lookup queries based on user input and well known address abbreviations. The system 100 then indexes all tables in the address lookup database 114 to allow for rapid queries by the user. The data can then be placed into separate specialized property databases that can be utilized to look up an address. The specialized property databases integrate all of the information input into the system including the public GIS data files 102, the public property databases 104, the MapPLUTO™ data files 106, and the non-digital zoning data 108.

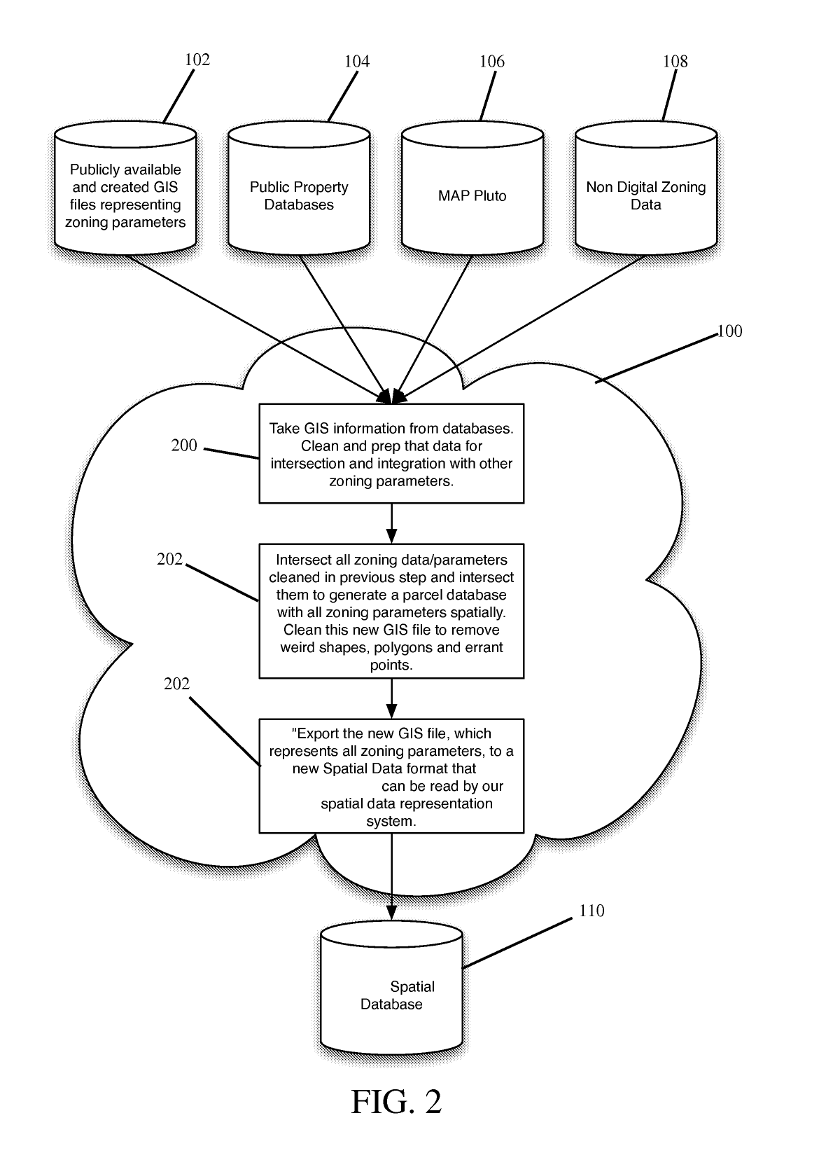

A flow diagram for creating the spatial database 110 according to an illustrative embodiment is described with reference to FIG. 2. As described above, the system 100 receives data including the public GIS data files 102, the public property databases 104, the MapPLUTO™ data files 106, and the non-digital zoning data 108. To create the spatial database 110, the system 100 compiles the GIS data from all of the data (including the public GIS data files 102, the public property databases 104, the MapPLUTO™ data files 106, and the non-digital zoning data 108) and cleans and prepares that data for intersection and integration with other zoning parameters, illustrated as 200.

The system 100 then intersects all of the clean zoning data and parameters to generate a parcel database with one or more new GIS file(s) including all of the zoning parameters spatially for each point or coordinate associated with the GIS file, illustrated as 202. Further, the system 100 cleans the new GIS file to remove any abnormal or odd shapes, polygons, and errant points. The clean new GIS file is exported by the system 100 to a new spatial data format so that the system 100 can read the new GIS file, illustrated as 204.

More particularly, the system 100 develops new GIS data files for different zoning parameters, for example, zoning parameters for New York City. In order to identify the areas on a parcel where zoning conditions are met, each zoning parameter must be digitized so that the geometric area of the parcel can be determined. In an illustrative embodiment, the system 100 converts the geometry stored in the ESRI GIS shapefile format to a geometric format that can be imported into the software tools used to develop the building envelope. Before the ESRI shapefiles are converted, they are uniquely combined to incorporate the zoning code requirements of the state and/or municipality. This allows for the import of the data/ESRI shapefiles and the eventual 3-D massing for any lot or combination of lots on a city block by the system 100. These GIS files may then be exported to the new spatial data format.

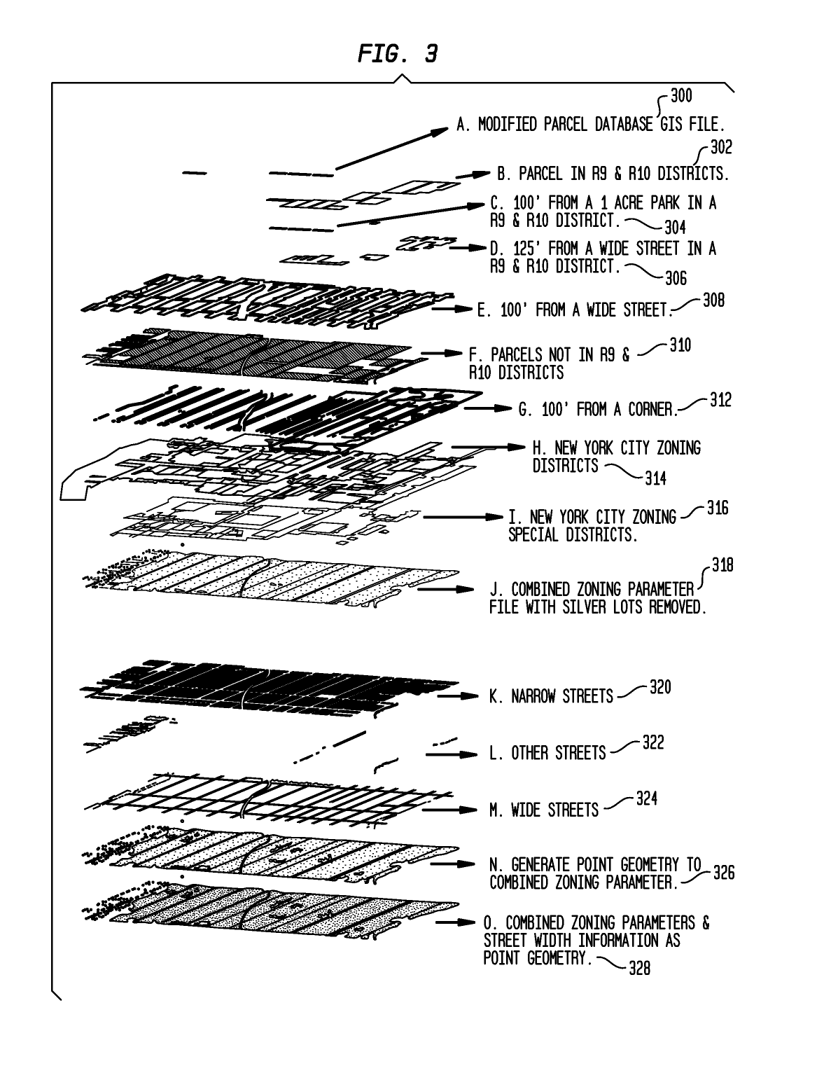

An embodiment of data elements that can be intersected or overlaid and incorporated in the GIS points according to an illustrative embodiment is described with reference to FIG. 3. As illustrated in FIG. 3, the system 100 merges the GIS database 102 with the non-digital zoning database information 108. The system 100 matches the zoning information of the city contained in the zone database 112 with the GIS information. The system 100 assesses the GIS information from every lot or parcel by specifying the placement of coordinates on the lot in the zoning database.

FIG. 3 illustrates examples of the data files that are extracted by the system 100 from the public GIS data files 102, the public property databases 104, the MapPLUTO™ data files 106, and the non-digital zoning data 108. These data files are then intersected and/or overlaid and incorporated into each GIS points or each coordinates, such as each longitude and latitude, on each lot in each city, etc. These data files can be thought of as acting as rules or operations that are applied to the GIS points in order to enable the system 100 to extrude a massing envelope based on the various zoning requirements for residential, commercial, and manufacturing zoning districts.

As illustrated in FIG. 3, one or more modified parcel database GIS files 300, which may be contained in the spatial database 110, are intersected with additional data. Using New York City as an example of a municipality in FIG. 3, each GIS point, coordinate, or longitude/latitude on every lot within the entire city of New York is intersected with the additional data to specify whether each GIS point is part of a specific zoning district that the city of New York has outlined across the city. More particularly, a table in the GIS PLUTO file is modified to include parameters for the intersection of additional data, such as the data described below. Fields are added to the modified parcel database 300 to specify zoning parameters, identify corner lots and through-lot situations, determine whether a lot can have a building on it, etc. This data is developed so each parcel's unique zoning specification is specified.

The system 100 is able to add additional data to the GIS points. More particularly, the system 100 adds data to identify GIS points within a zoning district, for example, where residential towers can be built. As an example, for New York City, the system 100 adds data to identify GIS points inside an R9 and/or R10 district. The system 100 takes the modified parcel database 300 and extracts only the parcels in the R9 and/or R10 districts 302. This allows the system 100 to identify parcels within the R9 and/or R10 districts and when such a parcel is massed the system 100 understands that the parcel can be massed as a residential tower and can prompt the user to specify whether or not the user wants a tower or not.

In this example, the system 100 adds data to identify GIS points one hundred feet from parks greater than one acre in size and within the R9 and/or R10 districts. A one hundred feet from parks greater than one acre data file 304 can be created by identifying those parks having an area over one acre in the GIS file of parks maintained by the New York City Parks Department. Once these parks are identified, a GIS operation is performed to measure one hundred feet from those parks. These measurements are then converted into the one hundred feet from parks greater than one acre data file 304. The identification of GIS points one hundred feet from parks greater than one acre in size is important in New York City, because a residential tower is not allowed to be built within 100 feet of a city park one acre or larger. Specifically, the intersection of GIS points in the R9 and/or R10 districts 302 and the one hundred feet from parks greater than one acre data file 304 is significant to the system 100. This allows the system 100 to understand that GIS points in the R9 and R10 districts 302 that are one hundred feet from parks greater than one acre 304 cannot have a residential tower built on them and the system 100 will not prompt the user to specify whether or not the user wants a tower.

In this example, the system 100 adds data to identify GIS points one hundred and twenty-five feet from a wide street and within the R9 and/or R10 districts. A one hundred and twenty five feet from a wide street data file 306 can be created by first identifying all of the parcel borders that are on a wide street, creating a new file from those edges, and then performing a GIS operation to determine the points one hundred and twenty-five feet from those edges. The resulting data file represents GIS points one hundred and twenty-five feet from a wide street 306. The identification of GIS points one hundred and twenty-five feet from a wide street can be important for zoning and real estate development purposes. In New York City there are two types of streets by zone: wide streets and narrow streets. Wide and narrow streets allow different setbacks, which can be defined as a distance between a building's street-facing wall and the front edge of the lot. For example, at a certain height the building has to come out of the setback, retreating towards the back of the lot. Depending on whether the GIS point is on a wide street or a narrow street, the setback of the building is a different distance. Thus, the system 100 uses the one hundred and twenty-five feet from a wide street data file 306 to identify GIS points on every plot, every lot, and every coordinate, that is next to a wide street.

Further, the system 100 adds data to identify GIS points one hundred feet from a wide street and within the R9 and/or R10 districts. A one hundred feet from a wide street data file 308 can be created by first identifying all the parcel borders that are on a wide street, creating a new file from those edges, and then performing a GIS operation to determine one hundred feet from those edges. The resulting data file represents the one hundred feet from a wide street data file 308. In this example, the identification of GIS points one hundred feet from a wide street can be important. In New York City, even if the GIS point is on a narrow street if the GIS point is within one hundred feet of the corner of a wide street, the wide street rules can be applied rather than the rules for narrow streets.

In this example, the system 100 adds data to identify GIS points outside a zoning district where residential towers can be built. For New York City, the system 100 adds data to identify GIS points outside the R9 and/or R10 districts. The system 100 takes the modified parcel database 300 and extracts only the parcels outside of the R9 and/or R10 districts and creates a data file 310 containing GIS points outside the R9 and/or R10 districts. This, allows the system 100 to identify GIS points outside the R9 and/or R10 districts where the residential tower rules do not apply.

Further, the system 100 adds data to identify GIS points one hundred feet from a corner. A one hundred feet from a corner data file 312 can be created by measuring the area which is considered one hundred feet from a corner, as defined by the City of New York in its official zoning text, and then digitizing that result as a new file. A lot which is one hundred feet or less from a corner is defined as a corner lot. In this example, the identification of GIS points one hundred feet from a corner is important because a corner lot has specific rules that are more liberal with respect to setback and lot coverage requirements. For example, in New York City, a corner lot may be allowed to build up to 100% of the lot coverage because air and light is accessible from two sides. Even for an interior lot that is within one hundred feet from a corner lot the more liberal rules for corner lots apply. In contrast, an interior lot not within one hundred feet from a corner may typically only be allowed to build up to about 60-70% lot coverage because air and light is only accessible from one side of the lot. Thus, the system 100 identifies every GIS point or coordinate, whether it is a corner lot or an interior, within one hundred feet of a corner. By identifying GIS points one hundred feet from a corner the system 100 can determine whether to apply the rule as applied to corner lots above.

In this example, the system 100 adds data to identify the zoning districts that each GIS point is part of. A zoning districts data file 314 can be created and/or provided by reference to municipality and/or state planning departments. For example, the zoning districts data file 314 can be provided by the New York City Department of Planning. In New York City there are several residential, commercial and manufacturing zoning districts. The system 100 can add data to each GIS point to identify which type of district each GIS point is in or a set of multiple districts that each GIS point is in. For example, in New York City some GIS points may be included in up to five zoning districts. Further, GIS sublots can be created within one parcel to identify the portions of the parcel that are part of different zoning districts. This allows the system 100 to identify the different parts of the site that correspond to different zoning districts.

In this example, the system 100 adds data to identify the GIS points within zoned special districts. A special zoning districts data file 316 can be digitized from zoning district specifications. The zoned special districts data file 316 may be developed and further modified to include, for example, street wall and setback information. The zoned special districts are typically districts other than the traditional zoning districts described above with reference to the zoning districts data file 314. In New York City, there are over twenty special districts that are associated with specific zoning rules written by the city. The system 100 adapts the special zoning data into digital form and maps the specific special district rules with each GIS point or coordinate within those districts.

In this example, the system 100 then combines the zoning parameter files, including all of the data files described above with reference to 300-316 and removes sliver lots to create a combined zoning parameter file with sliver lots removed 318. As mentioned above sub-lots may be created at times, especially when a GIS point is part of multiple zoning districts. When the system 100 intersects the data files, as described above with reference to 300-316, and applies these rules or operations to a specific coordinate of a parcel or site there may be lots that are very small, for example less than one foot. The very small lots are the sliver lots. The sliver lots can complicate the process of massing a site. Therefore, the system 100 combines all the data files, as described above with reference to 300-316, and removes all lots under a certain size.

As described above, whether the GIS point or parcel is on or near a wide street, narrow street, or other street can be important. The system 100 adds data to identify narrow streets, other streets, and wide streets. As illustrated in FIG. 3, a narrow street data file 320, an other street data file 322, and a wide street data file 324 is created. The narrow street data file 320 is created by identifying all the GIS points and parcel boundaries that are on narrow streets and extracting that geometry into a new GIS file. The other street data file 322 is created by identifying all the GIS points and parcel boundaries that are neither wide nor narrow streets (usually alleys) and extracting that geometry into a new GIS file. The wide street data file 324 is created by identifying all the GIS points and parcel boundaries that are on wide streets and extracting that geometry into a new GIS file. Using the narrow street data file 320, other street data file 322, and wide street data file 324, the system 100 can identify the type of street (narrow, wide, or other) that each GIS point or coordinate on every block in the entire city is located. In this example, this is important in enabling the system 100 to identify the frontage, specifically the front of the lot coordinates that identify where the street frontage is. The frontage identifies the address of a selected plot and whether the plot is on a wide, narrow, or other street.

The system 100 then generates point geometry to the combined zoning parameters 326, including all of the data files described above with reference to 300-324. This allows the system 100 to package the GIS points and coordinates into zones. The system 100 can then read a subset of information for each zone. The system 100 also generates combined zoning parameters and street width information as point geometry 328. In generating the combined zoning parameters and street width information as point geometry 328, the system 100 associates the wide, narrow, and other street information with the subsets of the packages. This allows the system 100 to mass out a parcel by wide, narrow, and other streets with the most general designation of what is different in the zoning sites.

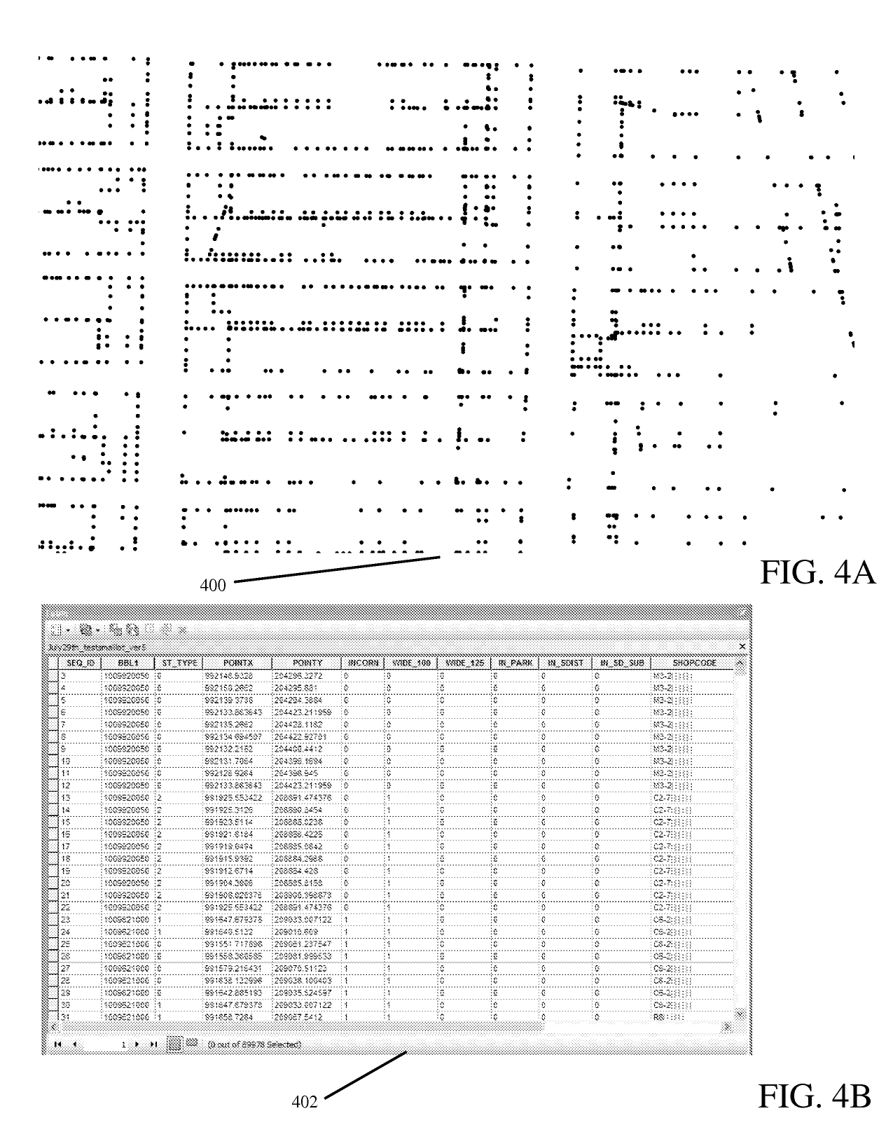

The combined zoning parameters and street width information according to an illustrative embodiment is described with reference to FIGS. 4A and 4B. FIG. 4A illustrates a 2-dimensional view of a GIS point coordinate structure 400. The GIS point coordinate structure is created by intersecting the GIS data files, as described with reference to FIG. 3, that represent different zoning parameters in order to add attribute information to each portion or coordinate of the lot or lots that might have distinct zoning rules associated with them. Specifically, the combined zoning parameters and street width information file 328 is created by intersecting data files 300-316 above to create a combined zoning parameter file, then the sliver lots are removed 318 from the file. The combined zoning parameters are then used to intersect with the street width information data files 320-324 and the system 100 creates a point coordinate structure from the data files generated, illustrated as 326 and 328. The GIS point coordinate structure 400 which holds the zoning rules can then be exported to a spatial database structure 402, as illustrated in FIG. 4B. The spatial database 110 now holds the spatial reference information for the zoning parameters. The spatial database structure 402 is not software specific, and can now be fed into the system 100 developed to generate 3-D massing.

While the data files illustrated and described with reference to FIGS. 3-4B are parameters that are important for massing property in New York City, it should be appreciated by one skilled in the art that any number and type of data files including any parameters for any city may be used.

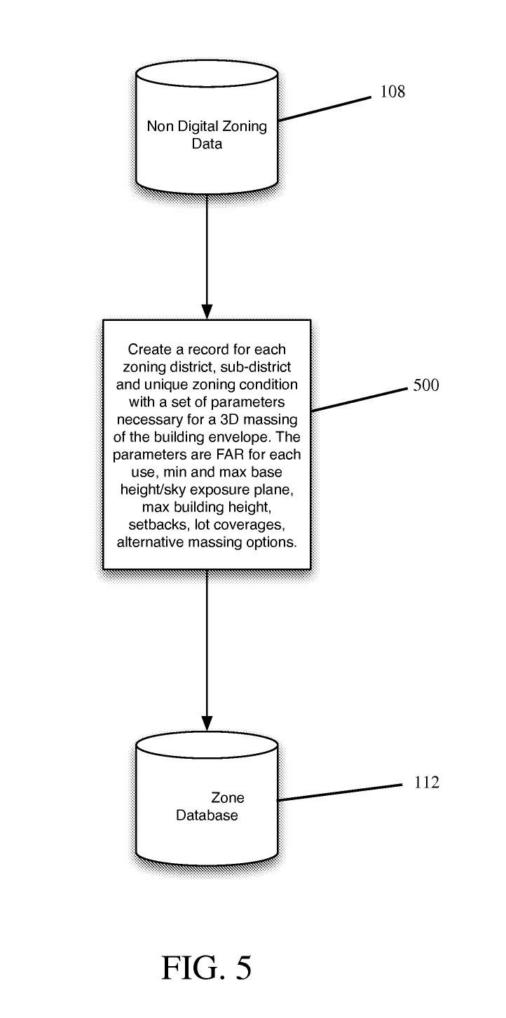

A flow diagram for creating the zone database 112 according to an illustrative embodiment is described with reference to FIG. 5. As illustrated in FIG. 5, the non-digital zoning data 108, i.e. the actual textual pages of a zoning code for a state or municipality, is digitized by the system 100. The system 100 then creates 500 a record for each zoning district, sub-district, and unique zoning conditions found in the non-digital zoning data 108 with a set of parameters necessary for a 3-D massing of a building envelope. For example, the parameters include a floor area ratio (FAR) for each use, minimum and maximum base height/sky exposure plane, bulk regulations for minimum and maximum streetwalls, building heights, maximum building heights, setbacks, lot coverage, tower rules, alternative massing options, and other parameters that, among others, an architect, real estate developer, or real estate broker would need to know in order to realize the greatest sized building envelope with the highest and best use(s) for any lot. The system 100 then compiles the parameters and zoning code information and places the data into the zone database 112. This allows the system 100 to access all of the zoning code information in response to a user entering the address of a site.

Using the zone database 112, the system 100 can access the geometric files in the zone database 112 in which each GIS point or coordinate contains information to perform a 3-D massing of a building envelope on a selected lot(s) consistent with the bulk regulations pursuant to the zoning code and its spatial relationship to public parks, street widths, corners, and locations within the block, which will be utilized to create an interactive 2-D geometric format and a 3-D representative massing of a building envelope.

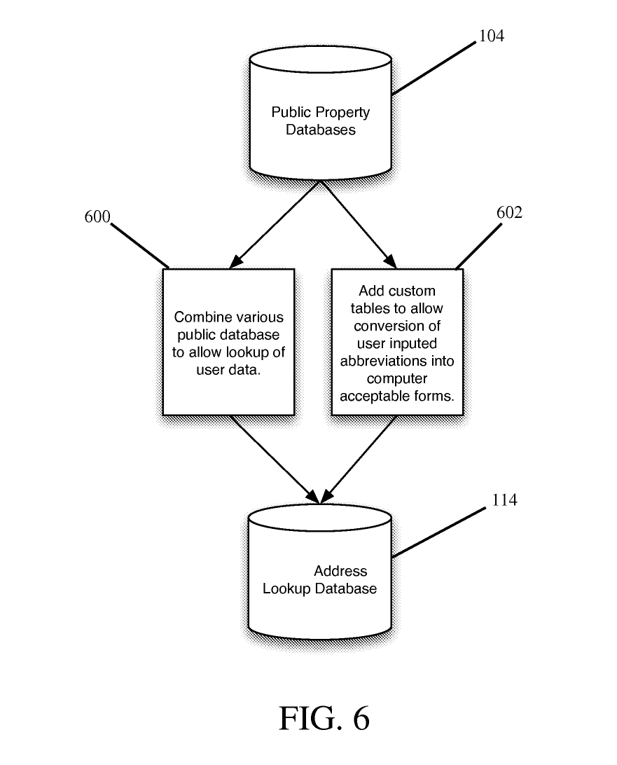

A flow diagram for creating the address lookup database 114 according to an illustrative embodiment is described with reference to FIG. 6. As illustrated in FIG. 6, the system 100 combines 600 the public property databases 104, which include public information about properties by lot, to allow the system 100 to lookup a user entered address, block number, lot number, Borough, Block, and Lot (BBL), etc, as previously described above. The system 100 has code and data added to the public information so that if the user does not have a complete address or enters in an abbreviation for an address the system 100 can still find the proper address or give a list of choices to present back to the user. Once the user selects the correct address the system 100 returns the legal BBL of the property. The returned data is also combined with the spatial database 110 and zone database 112, previously described, to allow the system 100 to access all of the data in the spatial database 110 and zone database 112 using only the address input by the user.

The system 100 further adds 602 custom tables to allow the system 100 to convert abbreviations input by the user into acceptable forms. For example, the system 100 can convert an address input by the user, such as “Park Place One”, “1 Park Place”, or “1 PK Place”, into an acceptable form to allow the system 100 to utilize the address and connect the address to the other databases in the system 100. This allows the system 100 to understand what property the user is trying to identify and allows the user to enter an address, block and lot number, or Borough, Block, and Lot (BBL) number in a number of ways. Thus, the lookup database 114 recognizes the address the user enters and allows the system 100 to identify relevant information derived from the address and/or block and lot number.

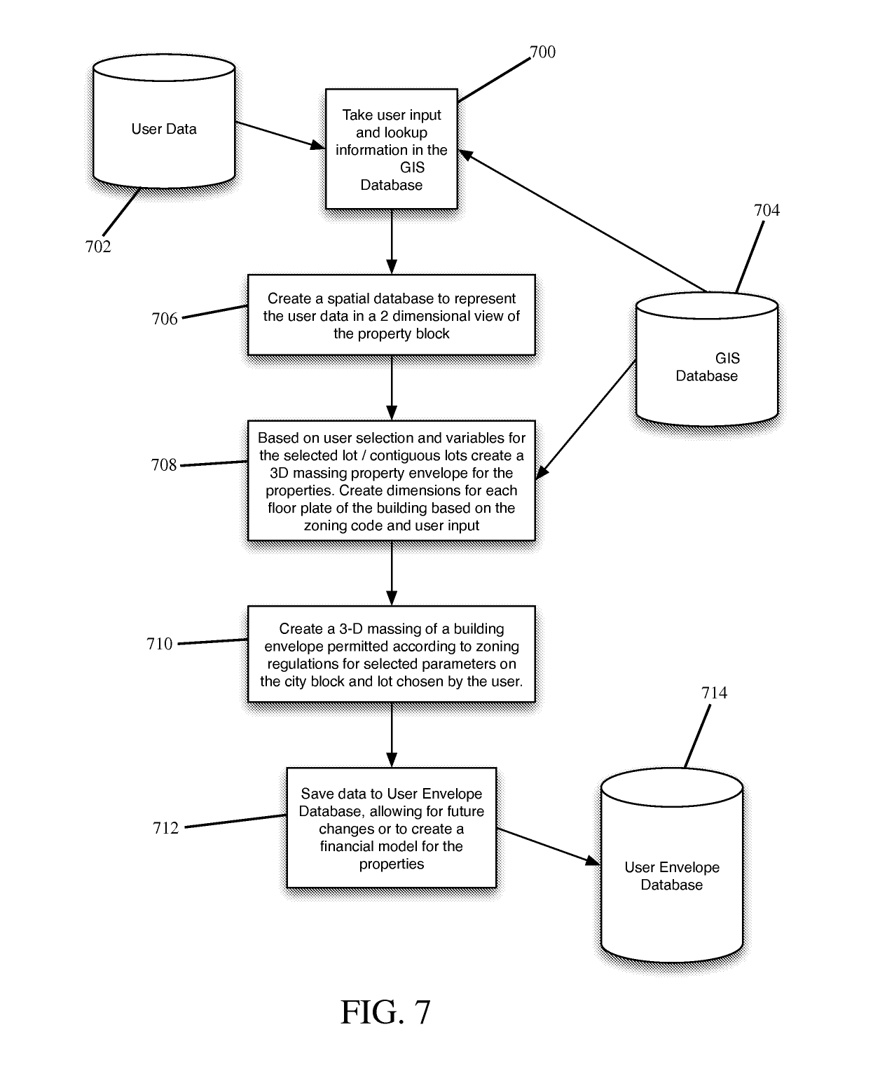

Using all of the information and data described with reference to FIGS. 1-6, the system 100 can generate a massing model. A method of how the system 100 generates a massing model according to an illustrative embodiment is described with reference to FIG. 7. As illustrated in FIG. 7, the system 100 receives 700 a user input, including user data 702, and looks up information associated with the user input in the system GIS database 704, which includes all of the information and data contained in one or more of the spatial database 110, the zone database 112, and the address lookup database 114. The user data 702 is an address or a BBL number for which the user wants the system 100 to determine the maximum building envelope for, and mass that building envelope on the parcel associated with the entered address or BBL. The user can simply enter as much information the user knows, i.e. an address, and the system 100 walks the user through the process of creating a 3-D massing envelope.

The system 100 translates the geometric files and coordinates to be utilized in a rendered 2-D format of a city block by combining co-linear edges and edges shorter than one foot in length with adjacent edges and creates 706 a spatial database to represent the user data 702 in a 2-D view of the property block. The user can scan and view relevant lot or parcel data and zoning information from the selected lot or combination of contiguous lots on the city block. Selected lots are assigned a unique zoning code that corresponds to the matching set of parameters in the zoning database 112. The system 100 then creates polygons with the specific coordinates of a given lot or combination of contiguous lots that are contained in one or more zoning districts or sub-districts, in order to produce a single massing.

Based on the user selected lot or lots the system 100 communicates with the system GIS database 704 and creates 708 a 3-D massing envelope for the user selected lot or lots including the maximum developable square footage within the legally allowed height, setbacks, and lot coverage requirements of any property. Further, the system 100 creates dimensions for each floorplate of the building massing based on the zoning code associated with the user selected lot or lots. The massing and dimensions are created using all of the information and data contained in one or more of the spatial database 110, the zone database 112, and the address lookup database 114, including the GIS points or coordinates intersected with all the key parameters and points and information from the public GIS files 102, public property databases 104, PLUTO database 106 and non-digital zoning data 108.

The system 100 then creates 710 the 3-D massing of the building envelope, as permitted according to the zoning regulations for selected parameters on the city block and lot chosen by the user, and places the massing on the user selected lot or lots based on the legal requirements for lot coverage and open space for both corner lots and interior lots. The system 100 contains all of the data required to perform the 3-D massing for every different possibility of every zoning district and every special use district, and applies a set of criteria to create the resulting 3-D massing.

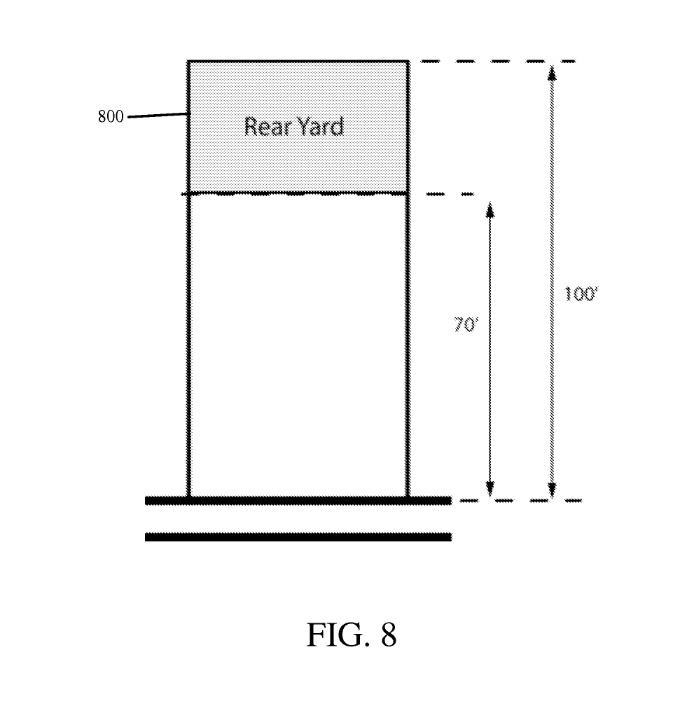

A diagram of lot coverage and rear yard requirements according to an illustrative embodiment is described with reference to FIG. 8. Based on all of the information described above with reference to FIGS. 1-7, the system 100 determines the applicable lot coverage and rear yard requirements for the user-selected lot or lots, and conforms the building envelope accordingly. As illustrated in FIG. 8 the lot is one hundred feet in length and has a rear yard 800 requirement of thirty feet. Thus, the building envelope cannot be placed on the rear thirty feet of the lot 800.

When determining lot placement there are a few elements, parameters, and/or zoning parameters that can be important, such as those found in the data files 300-328, described above with reference to FIG. 3. Thus, the system 100 can place the building on the lot based on the type of lot coverage and/or required yard that is legally allowed. As described above with reference to FIG. 3, the system 100 knows where all of the GIS points or coordinates are on a lot and is able to distinguish them and read the zoning code. The GIS points and coordinates tell the system 100 where the best placement of the yard or open space or lot coverage is. As mentioned above, there are at least two types of lots that the system 100 distinguishes, which include the interior lot and the corner lot. It is important for the system 100 to distinguish between an interior lot and a corner lot because, as mentioned above with reference to FIG. 3, interior lots and corner lots may have different zoning rules. As described above with reference to FIG. 3, the system 100 has mapped each GIS point or coordinate to the zoning rules.

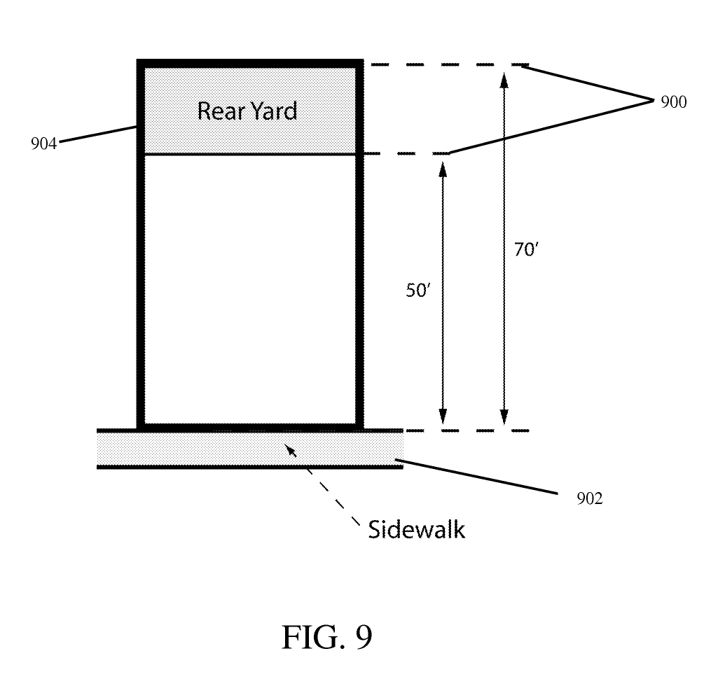

A diagram of a rear yard line for an interior lot according to an illustrative embodiment is described with reference to FIG. 9. As illustrated in FIG. 9, the system 100 calculates the lot coverage and rear yard requirements for the respective zone and determines which is more restrictive and calculates enough area in the rear of the lot to satisfy the requirement. Rear yard lines 900 are drawn parallel to the street frontage 902 of the lot, unless the lot is shallower than seventy feet from the frontage. If the lot is shallower than seventy feet, the zoning code permits the rear yard line to be proportionally closer to the street by a linear amount. As illustrated in FIG. 9, the lot has a length of seventy feet and a rear yard 904 requirement of twenty feet, and the rear yard lines 900 are drawn parallel to the street frontage 902.

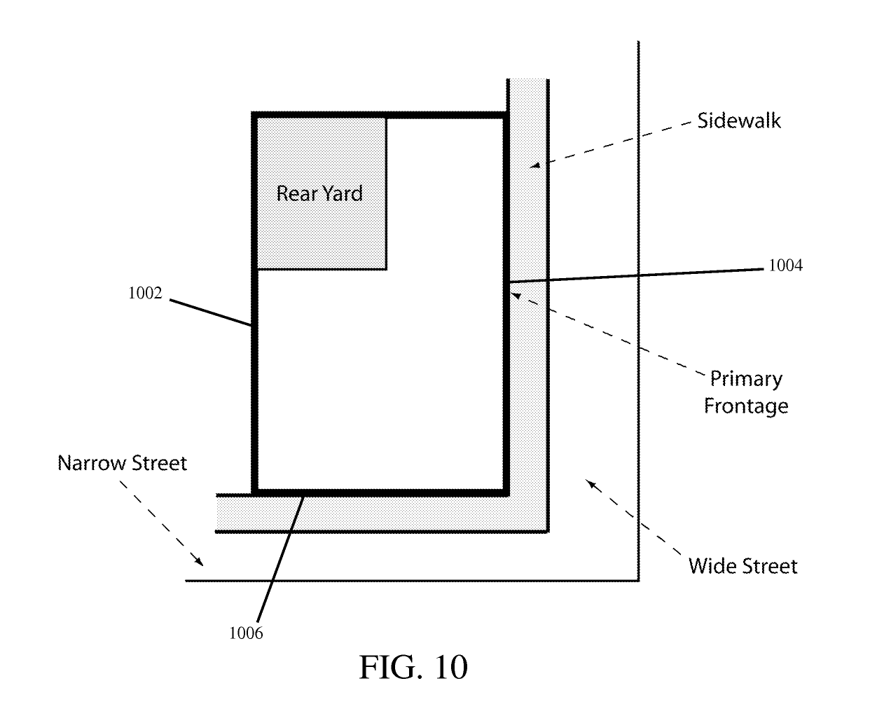

A diagram of a rear yard line for a corner lot according to an illustrative embodiment is described with reference to FIG. 10. The system 100 differentiates corner lots and lots with multiple street frontages. As illustrated in FIG. 10, the corner lot 1002 includes multiple street frontages. The corner lot 1002 has a wide street frontage 1004 and a narrow street frontage 1006. The system 100 recognizes this and determines which frontage is the primary street frontage, which is significant for massing strategies. As illustrated, the system 100 determined that the primary street frontage is on the wide street frontage 1004. For the most typical corner lots, which have no rear yard requirement, a maximum lot coverage of less than 100% necessitates the semblance of an open area in the rear, which generally is removed from the corner opposite the intersection of the two major frontages of the site.

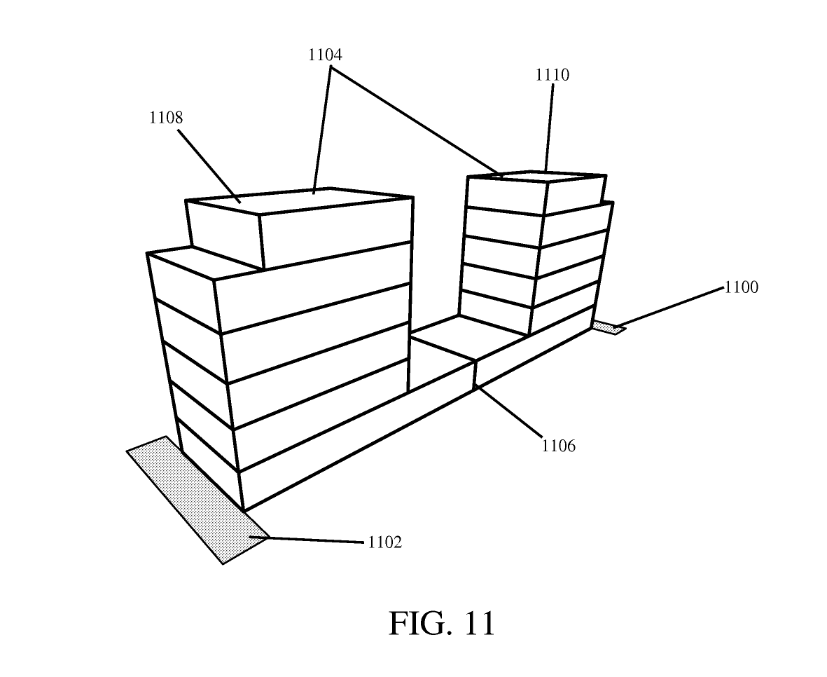

A diagram of massing for interior through-lots according to an illustrative embodiment is described with reference to FIG. 11. The system 100 identifies non-corner lots with multiple frontages 1100 and 1102 as interior through-lots 1104. The system 100 masses lots of this type by bisecting them with a line 1106 that is equidistant from two opposite frontages to produce a pair of interior lots 1108 and 1110. The system 100 then masses each of the lots 1108 and 1110 according to the appropriate rules, and considers the resulting envelopes as a single structure for reporting or calculating purposes.

Referring back to FIG. 7, the system 100 then presents the 3-D massing to the user and allows the user to make changes to the 3-D massing, such as, for example, changes in building height, floor height, and other variables in the massing. Upon the user making such changes the system 100 can re-mass the envelope based on the user choices.

The system 100 then saves 712 the user's massing envelope to a user envelope database 714 to allow the user to create a personal historical database. Thus, the system 100 allows the user to return to the system 100 and resume where the user left off or make future changes to the user's massing envelope. In an illustrative embodiment, the user envelope database 714 may include personal security passwords and user identifications to ensure that only an authorized user may enter a specific user's history. The user's history may include parameters that the user chose, for example, specific zoning choices to financial information that the user may want to use on an ongoing basis or that the user may want to check back on to view the historical choices and preferences for zoning and financial analysis.

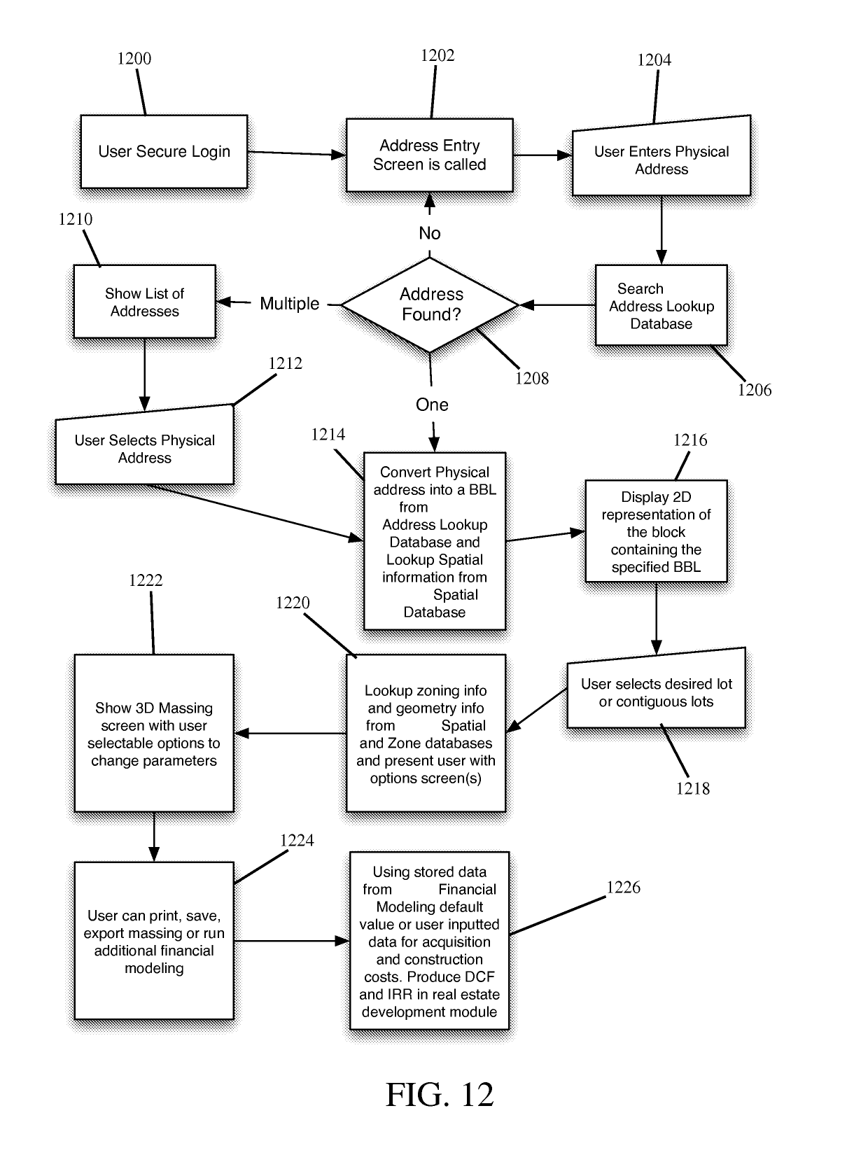

In an illustrative embodiment, the system 100 may be presented to a user through a web application. A flow diagram of the steps of a method for 3-D massing of a building envelope according to an illustrative embodiment is described with reference to FIG. 12. When a user initially accesses the system 100, typically via a user device, such as, but not limited to, a computer, personal digital assistant (PDA), cellular or mobile phone, and/or other devices that can access, provide, transmit, receive, and modify information over wired or wireless networks, the user may be presented 1200 with a secure login prompt via a graphical user interface. The secure login screen prompts the user to input a secure user identification and/or password or create an account. This allows the user to set up a personal account that only the user or other users authorized by the user have access to.

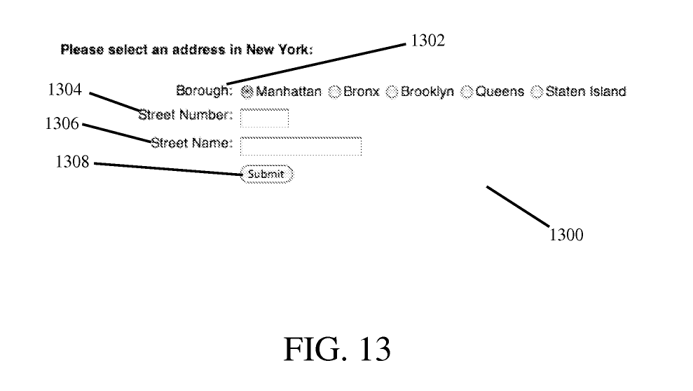

Once the user enters the user's login information, the user is presented 1202 an address entry prompt via the graphical user interface. A screen shot of an address entry prompt presented via the graphical user interface according to an illustrative embodiment is described with reference to FIG. 13. As illustrated in FIG. 13, the address entry prompt 1300 is presented to the user via the graphical user interface. The address entry prompt 1300 may include a borough selection area 1302, an input text box 1304 into which the user can enter a street number, an input text box 1306 into which the user can enter a street name, and a submit button 1308.

Referring to FIGS. 12 and 13, the user enters a physical address 1204, such as a street number and name into the address entry screen 1300 and selects submit by selecting the “Submit” button 1308. After the user selects submit 1308 the system 100 receives the user's address input and searches 1206 the address lookup database 114 for the address. The system 100 then determines 1208 whether the address is found, and if so, whether more than one address is found. If no address is found in the address lookup database 114, the system 100, may present 1202 the user with the address entry prompt 1300 again, or the system 100 may interact with the user. In an illustrative embodiment, the system 100 interacts with the user by providing options to the user, for example, if the user entered in “St”, the system 100 may prompt the user to specify whether the user meant “Street.” If the address is found in the address lookup database 114, the system determines if more than one address is found. If more than one address is found the system 100 presents 1210 the user a list of addresses and prompts the user to choose 1212 the desired address from the list of addresses. For example, if the user entered in “Hudson” and there is a “Hudson Street,” “Hudson Park,” and “Hudson Square,” the system 100 may prompt the user to clarify and choose which of the addresses the user desires to use.

After the user selects 1212 the desired address or if the system 100 only finds one address in the address lookup database 114 matching the address the user input, the system 100 resolves 1214 the input address to a unique Borough, Block, and Lot (BBL) identifier, which is a unique identifier for each parcel which allows the system 100 to read all of the GIS data contained in the system 100 for each site or parcel, such as the data described with reference to FIGS. 1-6. The system 100 then looks up all the information contained in the spatial database 110 and/or the zone database 112 for the user-selected address.

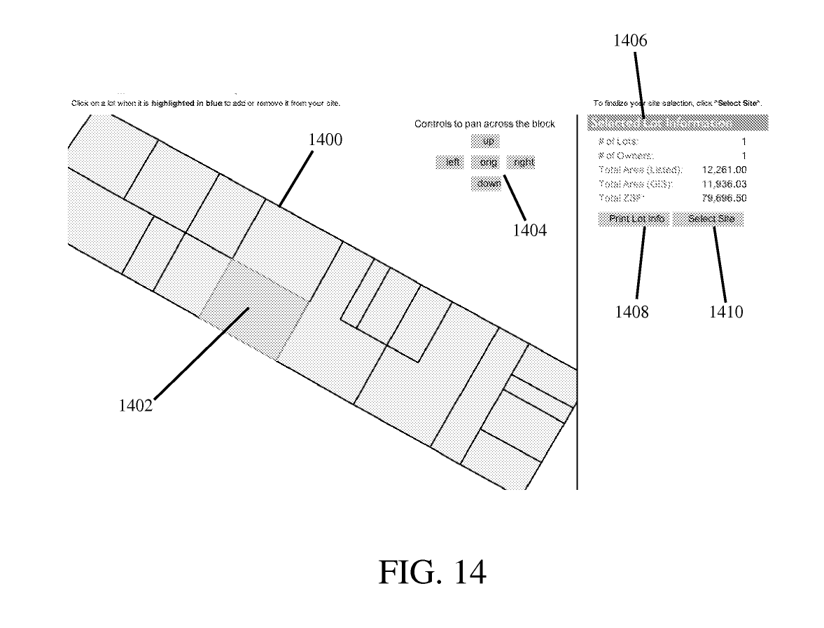

The system 100 then presents or displays 1216 a 2-D representation of a city block containing the BBL corresponding to the address the user selected. The user selects 1218 the lot or lots within the city block that the user wants the system 100 to analyze. A screen shot of the system 100 presenting the 2-D representation of the block containing the BBL according to an illustrative embodiment is described with reference to FIG. 14. The 2-D representation of the block containing the BBL is presented to the user via the graphical user interface. The graphical user interface presents a city block 1400 containing the BBL corresponding to the address the user selected 1402, which is highlighted. The user can pan across the city block 1400 using a mouse or via pan controls 1404.

Further, the system 100 allows the user to mouse over additional lots on the block to view information about each lot and to select contiguous lots in order to form a multi-lot parcel to analyze and develop in later steps. More particularly, the system 100 allows the user to scan the city block 1400 using the mouse and read legal information associated with each lot. The user can then select one or more lots. If the user selects more than one lot, the lots must be adjacent to one another. If the user does not choose adjacent lots the system 100 will inform the user that the user needs to choose adjacent lots because, for example, in New York City, and typically in other municipalities, multiple lots must legally be adjacent one another in order to be merged together. Once the user selects one or more lots, the system displays selected lot information 1406 in a panel on the graphical user interface. For example, the selected lot information 1406 may inform the user of the number of lots selected, the number of owners of the lots, the total area of the lots listed, the total GIS area of the lots, and the total zone square footage (ZSF) of the lots. Additionally, the user can print the selected lot information 1406 by selecting the “Print” button 1408. Once the user is satisfied that the user has selected the desired lot or lots, the user selects the “Select Site” button 1410.

Referring back to FIG. 12, once the user selects the desired lot or lots 1218, the system 100 looks up 1220 the zoning and geometry information for the selected lot or lots in the spatial database 110 and zone database 112 and presents the user with option prompts via the graphical user interface. More particularly, the system 100 looks up all of the information in the zone database 112 and spatial database 110 and walks the user through a series of questions that may be relevant to the user.

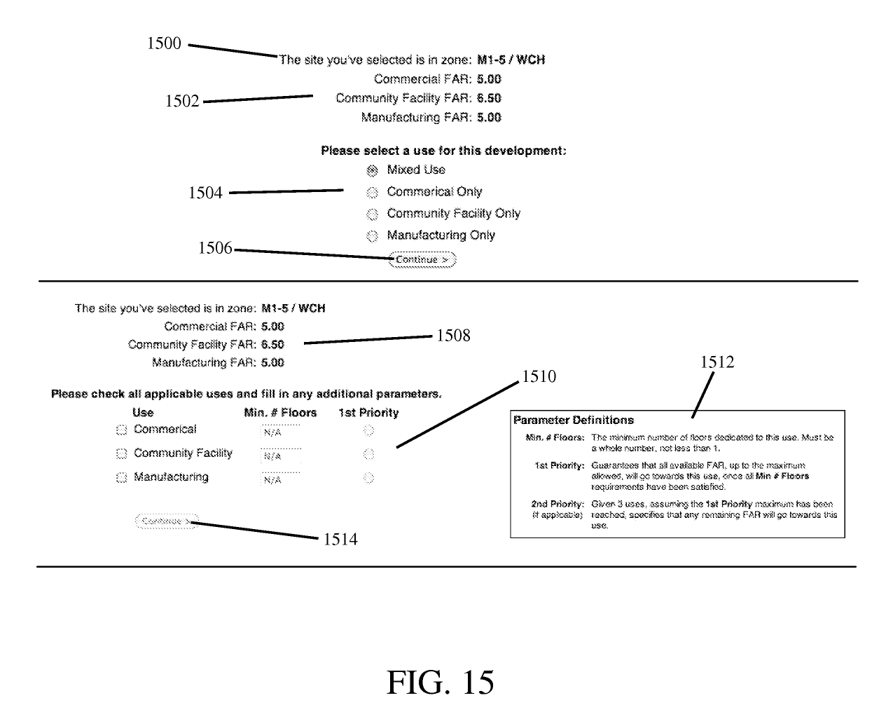

A screen shot of an option prompt or screen according to an illustrative embodiment is described with reference to FIG. 15. Based on the lot or lots selected 1218 by the user, the system 100 permits the user to choose and prioritize the allowable uses (for example, residential, commercial, manufacturing, etc.) of the building as permitted for the respective district and applicable zoning code sections. As illustrated in FIG. 15, the system 100 presents the user allowable use options via the graphical user interface. The system 100 identifies 1500 the zone or zones that the lot or lots the user has selected is in, and identifies 1502 the floor area ratios (FAR) for the various allowable uses based on the lot or lots selected 1218 by the user. The FAR is the amount of square footage permitted to be built per square foot on a given lot. As illustrated, the specific lot selected 1218 by the user may be used for commercial, community facility, and/or manufacturing.

The system 100 allows the user to select a desired use for the development based on the lot or lots selected 1218 by the user. The user selects the use for the development by selecting one of the options 1504 presented on the graphical user interface. As illustrated, the options 1504 include a mixed use option, commercial only option, a community facility only option, and a manufacturing only option. After the user selects the desired use, the user can proceed by selecting the “Continue” button 1506. As illustrated, the user has selected the mixed use option from the options prompt 1504. Additionally, the system 100 prompts the user to specify the number of floors the user desires to be used for each allowable use the user selected in the options prompt 1504.

As illustrated in FIG. 15, the system 100 identifies 1508 the zone or zones that the lot or lots the user has selected is located in and the floor area ratios (FAR) for the various allowable uses based on the option 1504 selected by the user. Additionally, the system 100 allows the user to select one or more of the desired uses, specify the minimum number of floors, and specify the priority level for selected uses by presenting additional parameters 1510 to the user via the graphical user interface. The system 100 may present a parameter definitions panel 1512 on the graphical user interface to assist the user in specifying the desired uses, minimum number of floors, and priority level for selected uses. For example, the parameter definitions panel 1512 may inform the user that the minimum number of floors dedicated to a certain use must be a whole number. The parameter definitions panel 1512 may inform the user that first priority guarantees that all available FAR, up to the maximum allowed, will go towards a selected use once all minimum floors requirements have been satisfied. The parameter definitions panel 1512 may inform the user that second priority specifies that any remaining FAR will go towards the selected use after the first priority maximum has been reached.

Once the user has selected the additional parameters 1510, the user selects the continue button 1514 to input the parameters into the system 100. It should be appreciated that the allowable use options illustrated in FIG. 15 are specific to the lot(s) the user has selected and that the allowable use options will change based on the lot(s) selected. The allowable use options are based on the legally allowable (i.e. based on the zoning code) choices that the user can make based on the lot(s) the user has selected. For example, a particular lot or site may only be zoned for commercial use. In this example, the system 100 will only present allowable use options associated with commercial use to the user via the graphical user interface. Thus, it should be appreciated by one skilled in the art that many different types and combinations of options can be presented to the user based on the lot(s) the user selects and the applicable zoning regulations.

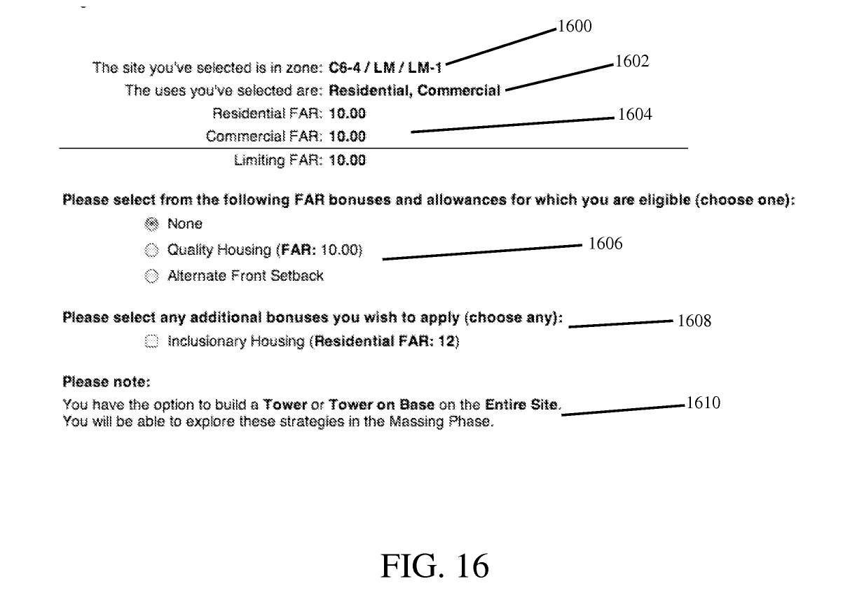

A screen shot of another option prompt or screen according to an illustrative embodiment is described with reference to FIG. 16. Based on the lot or lots selected 1218 by the user, the system 100 permits the user to select any floor area bonuses and allowances, for example, quality housing, inclusionary housing, plaza bonus, etc. As illustrated in FIG. 16, the system 100 presents the user FAR bonuses and allowances for which the lot(s) selected by the user is eligible via the graphical user interface. The system 100 identifies 1600 the zone or zones that the site is located in, identifies 1602 the uses the user has selected, and identifies 1604 the FAR for the various allowable uses based on the lot or lots selected 1218 by the user. As illustrated, the user has selected commercial and residential uses.

The system 100 allows the user to select FAR bonuses and allowances for which the site selected by the user is eligible. The user selects the desired FAR bonuses and allowances by selecting one of the options 1606 presented on the graphical user interface. As illustrated, the options 1606 include a none option, a quality housing option, and an alternate front setback option. Further, the system 100 allows the user to select additional bonuses for which the site selected by the user is eligible. The user selects the additional bonuses by selecting one of the options 1608 presented on the graphical user interface. As illustrated, the options 1608 include an inclusionary housing option.

Additionally, the system 100 may notify the user of possible massing options 1610, based on the site the user has selected, that the user will explore later in the process. As illustrated, the system 100 notifies the user that the user has the option to build a tower or tower on base on the entire site, 1610. It should be appreciated that the FAR bonus and allowance options illustrated in FIG. 16 are specific to the lot(s) the user has selected and that the FAR bonus and allowance options will change based on the lot(s) selected. The FAR bonus and allowance options are typically based on the legally allowable (i.e. based on the zoning code) choices that the user can make based on the lot(s) the user has selected. Thus, it should be appreciated by one skilled in the art that many different types and combinations of options can be presented to the user based on the lot(s) the user selects and the applicable zoning regulations.

Referring back to FIG. 12, based on the lot or lots selected 1218 by the user, the system 100 also permits the user to make selections for a massing strategy for the building envelope based on a series of questions and assumptions consistent with the zoning code, for example, alternative front setback, tower, tower-on-base, etc. Unless the user selects an alternative massing strategy permitted by the zoning code for the respective district, the system 100 masses the building envelope based on the regulations for the district(s) assuming maximum lot coverage.

Once the user has made all the available choices that are legally allowed, such as the choices described above with reference to FIGS. 15-16, for the user selected site, the system 100 combines the legal information on the selected lot or lots and runs through a number of analyses. The system 100 translates and reads the zoning information contained in the zone database 112 and the GIS spatial information contained in spatial database 110, and renders a 3-D massing of a building envelope based on the site selected by the user and the options chosen by the user.

The system 100 then presents the 3-D massing envelope to the user via the graphical user interface. The system 100 displays 1222 the 3-D massing along with user selectable options to the user via the graphical user interface. Typically, the 3-D massing of the building envelope is a maximum building envelope allowed based on the user selected site and user selected options. The selectable options presented to the user allow the user to change certain key parameters of the massing envelope, such as ceiling heights, floor heights, adding extra square footage, and other parameters of the type. In an illustrative embodiment, the system 100 uses an algorithm to initially mass, utilizing extremely shallow floorplates (depth equal to minimum setback) to guarantee that the maximum height will be reached. The system 100 then calculates the quantity of zoning square footage remaining and adds it in a uniform manner across the floorplates above 23 feet. Based on the minimum and maximum base heights, and maximum building height determined by the system 100 consistent with the zoning code, the user may choose a strategy to create a massing at a height within the legal parameters. The massing algorithm used by the system 100 may be an algorithm that is custom-made or commercially available, such as programs made by AutoDesk or other Computer-Aided Design (CAD) companies.

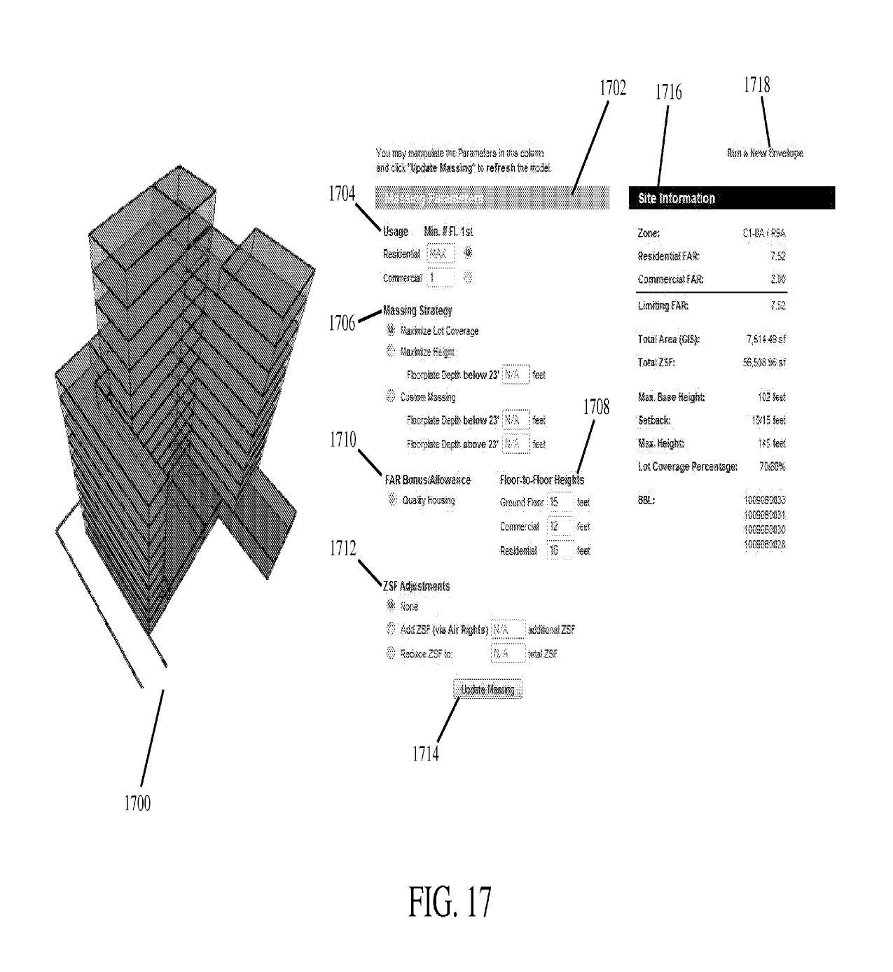

A screen shot of the 3-D massing and user selectable options according to an illustrative embodiment is described with reference to FIG. 17. As illustrated in FIG. 17, the system presents to the user a 3-D massing 1700 of the lots selected by the user along with user selectable options 1702 via the graphical user interface. The user has the ability to update or change and adapt the massing parameters, such as usage 1704, massing strategy 1706, floor-to-floor heights 1708, FAR bonus/allowance 1710, and zone square footage (ZSF) 1712, based on the user's preferences.

The system 100 allows the user to manipulate the lot usage 1704 by specifying the minimum number of floors and the priority level for the selected usage(s). The system 100 allows the user to manipulate the massing strategy 1706 by selecting a maximum lot converge option, a maximum height option, or a custom massing option. If the user selects the maximum height or the custom massing option, the system 100 allows the user to specifying specific floorplate depths for the floors above and/or below 23 feet.

The system 100 allows the user specify floor-to-floor heights 1708 for each specific program use, for example, for the ground floor of the building, residential, manufacturing, commercial, and/or community facility. The system 100 allows the user to manipulate the FAR bonus and allowances 1710. Further, the system 100 allows the user to specify the ZSF 1712 by adding or subtracting ZSF. The system 100 allows the user to select any number of options and re-mass the building envelope as many times as the user desires by selecting an “Update Massing” button 1714.

The system 100 may also present site information 1716 for the site(s) selected by the user. The site information 1716 may include zone type(s) and FAR for each use allowed, total area of the site(s), total ZSF of the site(s), maximum base height, setback, maximum height, lot coverage percentage, and the BBL for the site(s). Additionally, the system 100 may allow the user to run a new envelope by selecting the “Run a New Envelope” button 1718.

It should be appreciated that the user selectable options illustrated in FIG. 17 are specific to the lot(s) the user has selected and that the options will change based on the lot(s) selected. The user selectable options are typically based on the legally allowable (i.e. based on the zoning code) choices that the user can make based on the lot(s) the user has selected. Thus, it should be appreciated by one skilled in the art that many different types and combinations of options can be presented to the user based on the lot(s) the user selects and the applicable zoning regulations.

The system 100 allows the user to select any number of options, for example, the breakdown in square footage per floor, and the option to re-mass the building envelope as many times as the user desires. The system 100 also allows the user to save, print and/or export the 3-D massing, illustrated as 1224 with reference to FIG. 12.

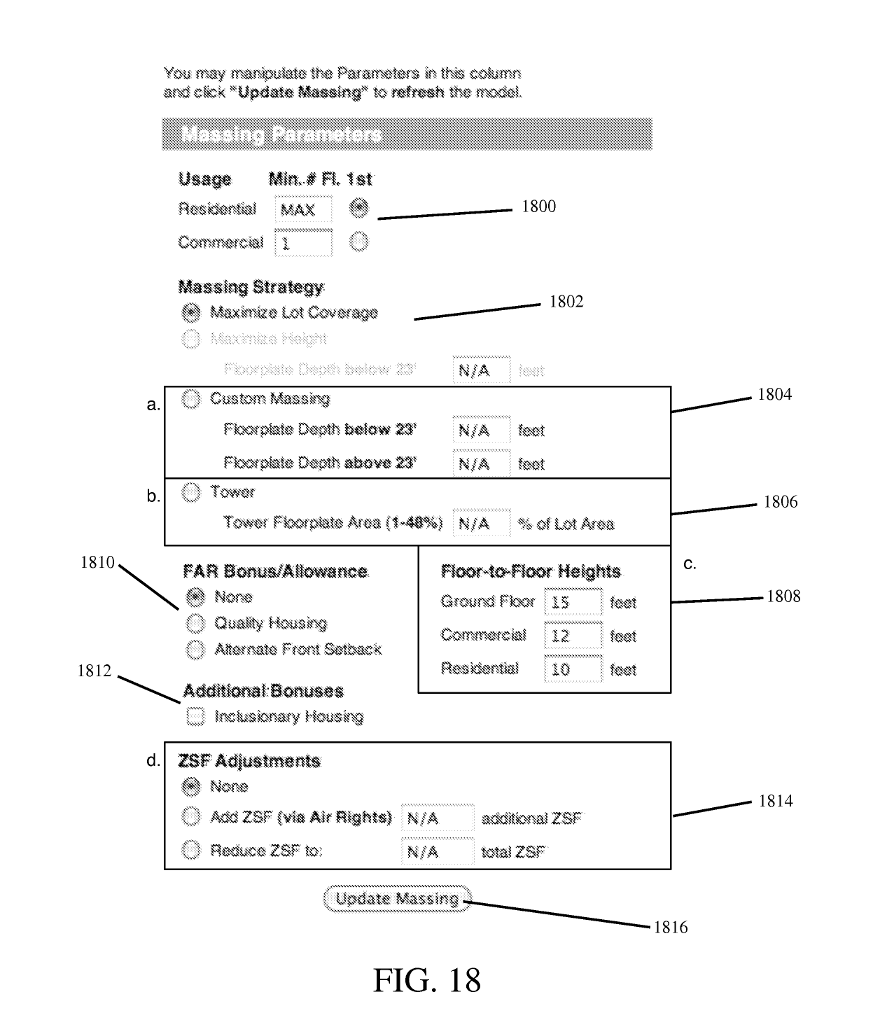

A screen shot of the massing parameters that the user can manipulate according to another illustrative embodiment is described with reference to FIG. 18. As illustrated in FIG. 18, the user has the ability to update or change and adapt the massing parameters, such as usage, massing strategy, floorplate depth, tower floorplate area, FAR bonus allowance, additional bonuses, floor-to-floor heights, and zone square footage (ZSF), based on the user's preferences.

As illustrated in FIG. 18, the system 100 presents the user with massing parameters that the user can manipulate via the graphical user interface. The system 100 allows the user to change the lot usage 1800 and the massing strategy 1802. The system 100 allows the user to perform a custom massing 1804 strategy by specifying specific floorplate depths for the floors above and below 23 feet.

In zoning districts where the zoning code permits, the option to mass a tower 1806 is presented. The system 100 observes relevant constraints and parameters when massing the tower, including the tower coverage for the base and the top floors. The system 100 allows the user to specify a specific tower floorplate area.

The system 100 allows the user to specify floor-to-floor heights 1808 for each specific program use; for example, for the ground floor of the building, residential, manufacturing, commercial, and/or community facility. The system 100 permits the user to interact and prioritize the various uses and options during the pre-massing phase, and/or change the minimum number of floors allocated for each use. The system 100 also allows the user to manipulate the FAR bonus and allowances 1810, and the additional bonuses 1812.

Further, the system 100 has the capacity to scan a city block, and calculate the potential FAR in square feet for each lot and permits the user to add or subtract FAR to/from their total according to the FAR limits of the zone and availability of adjacent lot(s). More specifically, the system 100 allows the user to specify the ZSF 1814 by adding or subtracting ZSF. The system 100 allows the user to select any number of options and re-mass the building envelope as many times as the user desires by selecting the “Update Massing” button 1816. The system 100 also allows the user to save, print and/or export the 3-D massing, illustrated as 1224 with reference to FIG. 12.

It should be appreciated that the massing parameters illustrated in FIG. 18 are specific to the lot(s) the user has selected and that the massing parameters will change based on the lot(s) selected. The massing parameters are typically based on the legally allowable (i.e. based on the zoning code) choices that the user can make based on the lot(s) the user has selected. Thus, it should be appreciated by one skilled in the art that many different types and combinations of massing parameters can be presented to the user based on the lot(s) the user selects and the applicable zoning regulations.

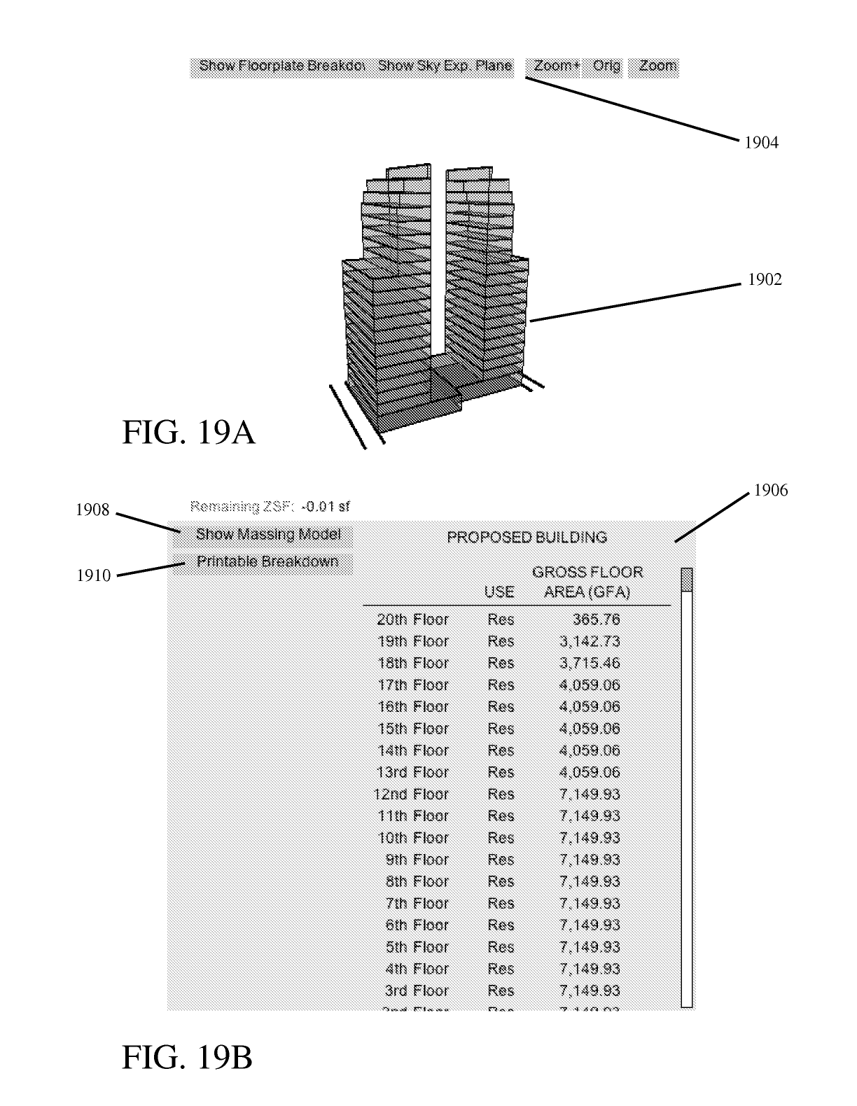

In an illustrative embodiment, the system 100 can provide the user with a 3-D massing model and a chart that breaks down the floor area of each floorplate of the 3-D massing. Screen shots of the 3-D massing and floor breakdown chart for a proposed building according to an illustrative embodiment are described with reference to FIGS. 19A-B. After the system 100 runs the massing algorithm, the resulting massing of the building envelope is visualized in 3-D. As illustrated in FIG. 19A, the system 100 presents the user with the 3-D visualization 1902 via the graphical user interface. The system 100 allows the user to change the views of the 3-D massing by selecting one or more of the controls 1904. If the user desires to view the floorplate breakdown of the 3-D massing, the user can select the show floorplate breakdown control from the controls 1904. Other views can be implemented by the user via the graphical user interface. Illustratively, the massing displayed can be viewed from various angles and/or rotated through various angles as a function of the CAD program implementing the massing algorithm.

As illustrated in FIG. 19B, the system presents the user with a chart of the floor area of each floorplate 1906 via the graphical user interface. The floorplate breakdown 1906 includes the number of floors in the 3-D massing, the use of each floor (i.e. residential, commercial, community facility, manufacturing, and the gross floor area of each floor). If the user desires, the system 100 allows the user to view the 3-D massing model by selecting a “Show Massing Model” button 1908. Additionally, the system 100 allows the user to print the floorplate breakdown 1906. To print the floorplate breakdown 1906, the user can select the “Printable Breakdown” button 1910 to convert the floorplate breakdown 1906 to a printable format.

Referring back to FIG. 12, the system 100 allows 1224 the user to save, print and/or export the 3-D massing in digital format. Additionally, the system 100 allows the user to go back and change the massing parameters as described above with reference to FIGS. 17 and 18, and even allows the user to run financial modeling based on the 3-D massing preferences or new choices. More particularly, using stored or input data identifying acquisition and construction costs, the system 100 can calculate 1226 the viability of the property as a real estate development investment by calculating a discounted cash flow (DCF) and/or an internal rate of return (IRR) and/or other investment metric values.

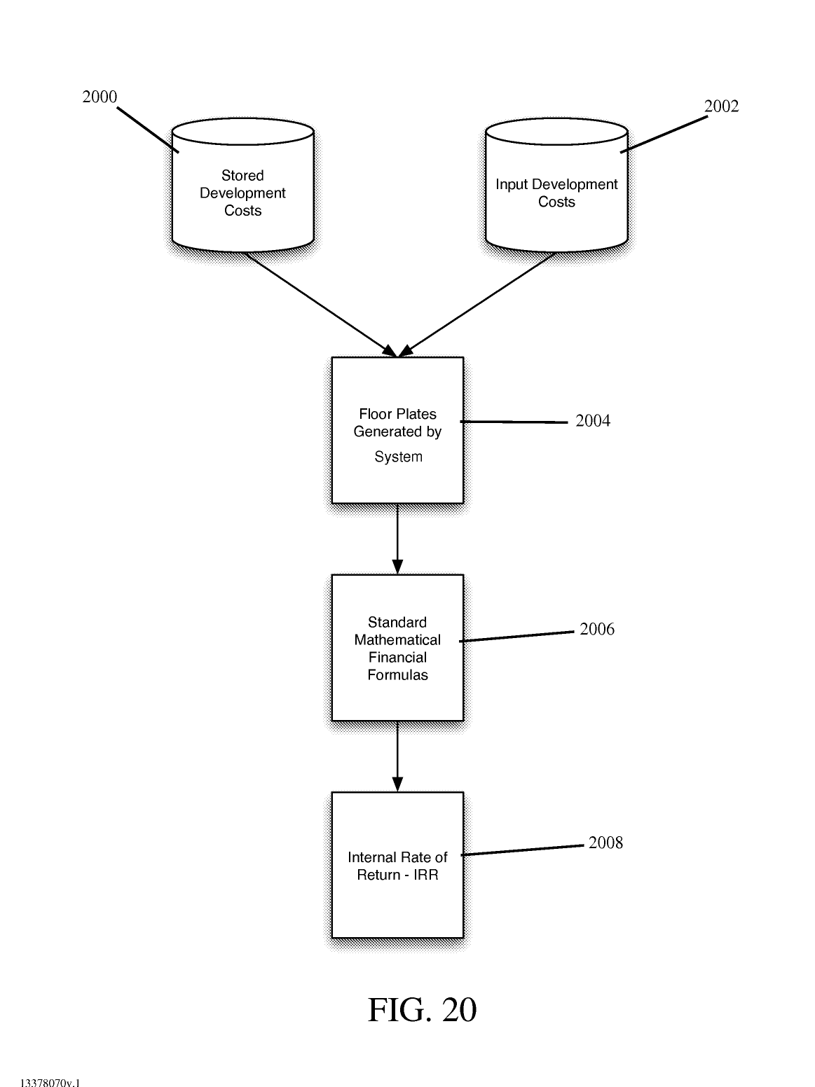

A flow diagram of calculating an internal rate of return value according to an illustrative embodiment is described with reference to FIG. 20. As illustrated in FIG. 20, the system 100 includes stored development cost data 2000 and/or input development cost data 2002 identifying property acquisition, site preparation, construction, and other financial costs and stored and/or input data identifying property sales and lease rates. Using the stored and/or input data 2000 and 2002 the system 100 applies 2004 the stored and/or input data 2000 and 2002 against the floor area of each floorplate generated during massing. Using standard mathematical financial formulas, the system 100 then calculates 2006 the viability of the property as a real estate development investment by calculating a discounted cash flow (DCF) and/or an internal rate of return (IRR) 2008 and/or other investment metric values.

While the systems and methods disclosed herein are described and illustrated in connection with certain embodiments, many variations and modifications will be evident to those skilled in the art and may be made without departing from the spirit and scope of the disclosure. For example, while illustrative embodiments refer to New York City in some examples, the systems and methods can be applied to any location. The systems and methods disclosed herein are thus not to be limited to the precise details of methodology or construction set forth above as such variations and modification are intended to be included within the scope of the disclosure.

What is claimed is:

1. A system for 3-D massing of a building envelope comprising:
a graphical user interface receiving information from a user, including information identifying a parcel of land;
a plurality of data stores storing data, including geographic location data corresponding to the parcel of land, and zoning data corresponding to zoning parameters associated with the parcel of land;
a processor receiving data from the plurality of sources, the processor generating geographic information data files based on the geographic location data and the zoning data, each geographic information data file corresponding to a zoning parameter of the parcel of land, the processor overlaying and intersecting the geographic information data files to create geographic point data, the geographic point data providing a spatial representation of the zoning parameters for a plurality of geographic coordinates of the parcel of land, and the processor generating a massing of a building envelope for the parcel of land according to the zoning parameters of the parcel of land based on the geographic point data; and
the graphical user interface receiving the massing of the building envelope for the parcel of land from the processor and displaying the massing.

2. The system of claim 1, wherein the processor further removes from the geographic point data abnormal or erroneous data in the geographic point data.

3. The system of claim 1, wherein the processor further determines at least one of: a floor area allowance value for the parcel of land, a lot coverage amount for the parcel of land, a rear yard requirement amount for the parcel of land, and a floor area ratio for the parcel of land in generating the massing of the building envelope for the parcel of land.

4. The system of claim 3, wherein in generating the massing of the building envelope for the parcel of land, the processor determines a priority between the lot coverage amount and the rear yard requirement, and determines a rear yard line based on the priority.

5. The system of claim 1, wherein the graphical user interface provides to the processor an input for at least one of: a priority of program use(s) of the parcel of land, a lot coverage, a building base and maximum height, and setback, and a floor height.

6. The system of claim 5, wherein, in response to input from the graphical user interface, the processor generates the massing of the building envelope for the parcel of land or a combination of parcels of land according to the input and performs multiple massings based on modifications made by the user directly in the graphical user interface.

7. The system of claim 1, wherein the processor determines an investment viability value for the massing of the building envelope for the parcel of land.

8. A method of 3-D massing of a building envelope comprising:
receiving, through a graphical user interface, information from a user identifying a parcel of land;
accessing a plurality of data stores storing data, including geographic location data corresponding to the parcel of land, and zoning data corresponding to zoning parameters associated with the parcel of land;
generating, by a processor, geographic point data by intersecting geographic location data corresponding to the parcel of land and zoning data corresponding to zoning parameters associated with the parcel of land, the geographic point data providing a spatial representation of the zoning parameters for a plurality of geographic coordinates of the parcel of land;
generating, by the processor, a massing of a building envelope for the parcel of land according to the zoning parameters of the parcel of land based on the geographic point data; and
displaying, on the user interface, the massing of the building envelope for the parcel of land.

9. The method of claim 8, further comprising displaying, on the graphical user interface, a land area diagram including the parcel of land.

10. The method of claim 8, further comprising determining, by the processor, at least one of: a floor area allowance value for the parcel of land, a lot coverage amount for the parcel of land, a rear yard requirement amount for the parcel of land, and a floor area ratio for the parcel of land.
